(19) United States
(12) Patent Application Publication
(10) Pub. No.: US 2015/0332174 A1
(43) Pub. Date: Nov. 19, 2015

(54) SYSTEM AND METHOD FOR ENHANCED VEHICLE PARKING SPACE UTILIZATION

(71) Applicants: Zachary Folkman, Montclair, NJ (US); Chase Herro, Poway, CA (US)

(72) Inventors: Zachary Folkman, Montclair, NJ (US); Chase Herro, Poway, CA (US)

(21) Appl. No.: 14/276,613

(22) Filed: May 13, 2014

(51) Int. Cl. G06Q 10/02

(52) U.S. Cl. CPC G06Q 10/02

(57) ABSTRACT

A method for facilitating utilization of a vehicle parking space. The method includes causing a computing device to graphically display a location of a personal parking space in geographic vicinity of a vehicle as being available for parking, wherein availability of said personal parking space is designated based on an input from an interest holder in the personal parking space. The method further includes receiving user selection of the available personal parking space, receiving user selection of parking time during which the vehicle will occupy the selected personal parking space, and designating the personal parking space as unavailable during the parking time selected by the user.

### FIELD OF THE INVENTION

The present invention relates generally to vehicle parking systems and more particularly to an enhanced system for parking space utilization.

### BACKGROUND

With a continuing rise in population, the urban congestion presents a challenging environment for city dwellers and city planners alike. Management and availability of vehicle parking in busy city centers, as well as in other areas with limited parking space, is a particularly challenging problem, especially in situations when public transport options are limited or not available. Yet, thousands of vehicles must enter areas with limited public parking on daily basis in order to come to work, home or do shopping, and must all compete for the same limited public parking space. Given that limited availability of public parking is an ongoing concern in most metropolitan areas, drivers who do not own a private parking space or have made previous arrangements to rent one have very limited options.

While availability of public parking is often at a premium, consumer owned parking spaces are frequently underutilized, such as when a personal parking space owner or lessee goes on vacation or leaves for an extended business trip. Yet, no one else is allowed to occupy these temporarily vacant parking spaces due to the existence of a personal ownership or lease interest in the space. Additionally, the owners or lessees of temporarily vacant personal parking spaces must continue to pay premium for these parking spots even during periods of their temporary vacancy.

### SUMMARY

The systems and methods described herein address the foregoing deficiencies of the public parking space rental systems by creating a new market for consumer-to-consumer rentals of personal parking space. As described in detail below, embodiments of the system and method described in the present disclosure permit owners or lessees of personal parking spaces to designate such parking spaces as being temporarily available for rent to other consumers or third parties, thereby relieving the shortage of public parking and providing the personal space interest holders with a way to recoup costs during temporary vacancy. Among other features discussed below, certain embodiments provide an auction, such as a name-your-price style auction, for renting the personal parking spaces designated by their owners or lessees as being temporarily unoccupied.

In one embodiment of the present disclosure, a method for facilitating utilization of a vehicle parking space is provided. The method includes causing a computing device to graphically display a location of a personal parking space in geographic vicinity of a vehicle as being available for parking, wherein availability of said personal parking space is designated based on an input from an interest holder in the personal parking space. The method further includes receiving user selection of the available personal parking space, receiving user selection of parking time during which the vehicle will occupy the selected personal parking space, and designating the personal parking space as unavailable during the parking time selected by the user.

In another embodiment, a system is provided for facilitating utilization of a vehicle parking space. The system includes a computing device configured to graphically display a location of a personal parking space in geographic vicinity of a vehicle as being available for parking, wherein availability of said personal parking space is designated based on an input from an interest holder in the personal parking space. The system further includes a parking server configured to receive user selection of the available personal parking space, receive user selection of parking time during which the vehicle will occupy the selected personal parking space, and designate the personal parking space as unavailable during the parking time selected by the user.

In yet another embodiment, a non-transitory computer readable medium is provided having stored thereon computer executable instructions for facilitating utilization of a vehicle parking space. The instructions include causing a computing device to graphically display a location of a personal parking space in geographic vicinity of a vehicle as being available for parking, wherein availability of said personal parking space is designated based on an input from an interest holder in the personal parking space. The instructions further include receiving user selection of the available personal parking space, receiving user selection of parking time during which the vehicle will occupy the selected personal parking space, and designating the personal parking space as unavailable during the parking time selected by the user.

Additional features and advantages of embodiments will be set forth in the description which follows, and in part will be apparent from the description. The objectives and other advantages of the invention will be realized and attained by the structure particularly pointed out in the exemplary embodiments in the written description and claims hereof as well as the appended drawings. It is to be understood that both the foregoing general description and the following detailed description are exemplary and explanatory and are intended to provide further explanation of the invention as claimed.

### BRIEF DESCRIPTION OF THE DRAWINGS

The preferred embodiments of the present invention are illustrated by way of example and not limited to the following figures:

FIG. 1 is a schematic diagram illustrating a general system environment of a parking system, in accordance with an embodiment of the present invention;

FIG. 2 is a flowchart of a method for reserving a personal parking location that is subject to a pre-existing ownership interest, in accordance with an embodiment of the present invention;

FIG. 3 is a flow chart of a method for designating a personal parking space as being available for rent, in accordance with an embodiment of the present invention; and

FIG. 4 illustrates a schematic of a mobile device of FIG. 1, in accordance with a further exemplary embodiment of the present invention.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

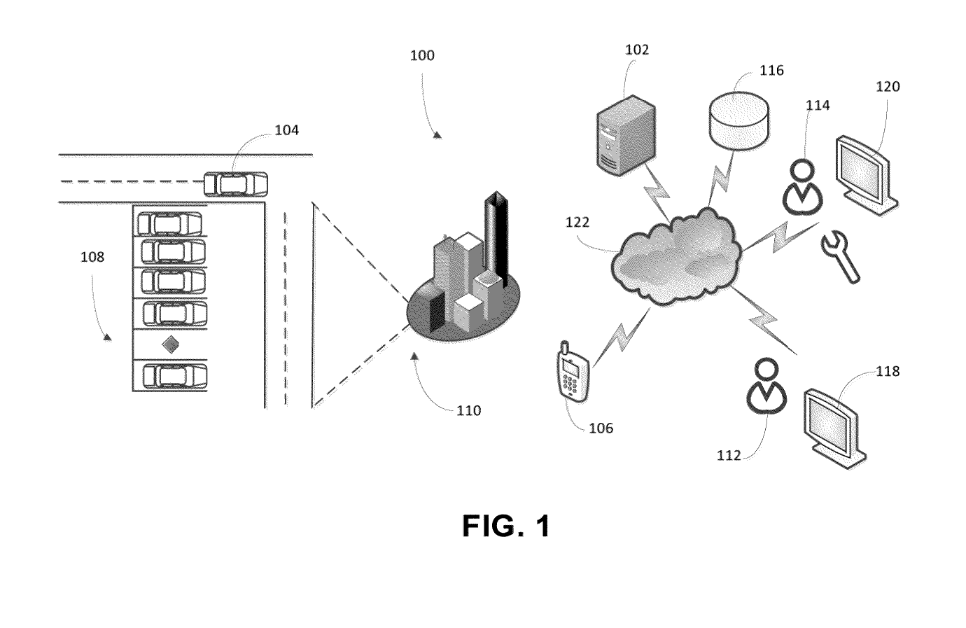

FIG. 1 is a schematic diagram illustrating an embodiment of a general system environment of the parking system 100. In general, the parking system 100 implements a crowdsourcing approach to solving the parking shortage by facilitating reservation of an unoccupied personal parking space by a user when another user has a pre-existing interest in such personal parking space, such as an ownership or a lease interest. Therefore, embodiments of the system 100 facilitate consumer-to-consumer rentals of temporarily unoccupied personal parking spaces. For instance, the system 100 allows an owner of a personal condo spot to offset his or her gas costs by designating the spot as being temporarily available for rent by third parties. In another example, a consumer who leases a parking spot near work but expects to be on vacation may to re-coup some of their costs by designating the spot as being available for rent to other drivers via the system and methods described in detail below.

In one embodiment, the parking system 100 notifies a driver of availability of nearby personal parking spaces in which another user has an interest, such as an ownership or lease interest, and which have been designated by such person as being available for rent, sub-lease, or similar arrangement. In particular, the parking server 102 determines geographic location of the vehicle 104 and/or the driver's mobile device 106 in order to present the driver with a graphical representation 108 of an available parking space in vicinity of the driver's location 110. As described in further detail below, the driver 112 may initiate the search for available parking space by invoking execution of a software application for displaying the personal parking spaces that have been designated by an interest holder 114 as being available for rental or sublease. The software application further includes computer executable code for processing payment for the selected personal parking space, among other features further discussed below.

In the illustrated embodiment, the parking system 100 includes a user database 116 that stores user information, including driver and parking space interest holder information, as well as their respective payment preferences and other settings. Alternatively or in addition, the user database 116 may be collocated with geographically or physically (e.g., part of the same server machine or server network) with the parking server 102. As further illustrated in FIG. 1, the driver 112 may optionally elect to use a personal computer or another computing device 118 located away from the desired parking location and executing the parking application discussed herein, such as when the driver wishes to make sure that the parking space will be available upon arrival to the location of interest. Optionally, the physical parking space location may include a status light, such as a color bulb, LED, or the like indicative of the availability status of the parking space based on color (e.g., green indicates that the space if available, while red indicates that the space is no longer available, even if unoccupied). The interest holder 114 designates availability of the parking space by invoking execution of the subject parking space application via a computing device 120, which may be a personal computer or a mobile device such as a smartphone, tablet computer, or the like. In various embodiments, the parking space application discussed herein includes computer readable program code stored in non-transitory computer memory and executed in whole or in part by respective processors of one or more of the mobile device 106, computing devices 118, 120, the parking server 102, and/or a telematics unit of the vehicle 104.

The above recited elements of the parking system 100 are connected via an electronic network 122. In various embodiments, the network 122 includes a wireless wide area network (WWAN), including without limitation a network employing a cellular-based wireless access standard, such as CDMA 2000 1X, 1xEV-DO, 1xEV-DV, GSM, GPRS, EDGE, HSPDA, UMTS, LTE (3GPP Long Term Evolution), UMB (Ultra Mobile Broadband), as well as WiMAX-based network access technology. In a further embodiment, the network 122 is a wireless local area network (WLAN) (e.g., Wi-Fi).

In one embodiment, the parking space application described herein accepts auction style bidding for personal parking spaces designated as being available by their owners or lessees, such as when a minimum parking rate is set by the space owner below which the space will not be rented. During times of high demand, the system provides rental income above the minimum rate set by the space owner. In another embodiment, the system accepts a name-your-price bid and a geographical area where the driver wishes to find parking. When the driver-designated rental rate is at or above the minimum rental rate designated by the owner or lessee of the personal parking space located within the selected geographical area, the space undergoes a reservation process.

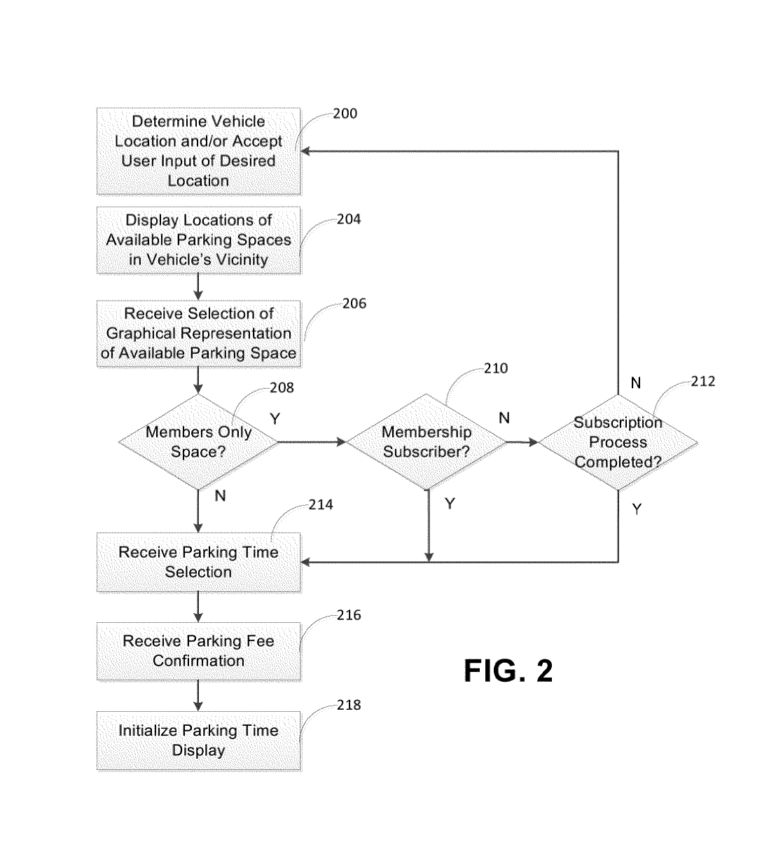

FIG. 2 is a flowchart of a method for reserving a personal parking location that is subject to a pre-existing ownership interest. In step 200, the parking server 102 determines location of the driver's vehicle, such as by receiving Global Positioning System (GPS) coordinates of the driver from the mobile device 106 and/or a telematics unit within the vehicle 104 via the network 122. Alternatively, the parking server 102 receives the location, such as an address or another area designator, near which the driver wishes to find an available parking space by processing user input supplied through the computing device 118 prior to the driver arriving at the vicinity of the desired location. In step 204, the parking server 102 causes the display of locations in the vicinity of the driver's vehicle (or in a pre-selected area) of available personal parking spaces that have been designated by users having an ownership interest therein (e.g., full ownership, or long-term lease interest) as being unoccupied and available. In step, 206, the parking server 102 receives driver's selection of a graphical representation 108 of an available parking space in order to initiate the reservation and payment process.

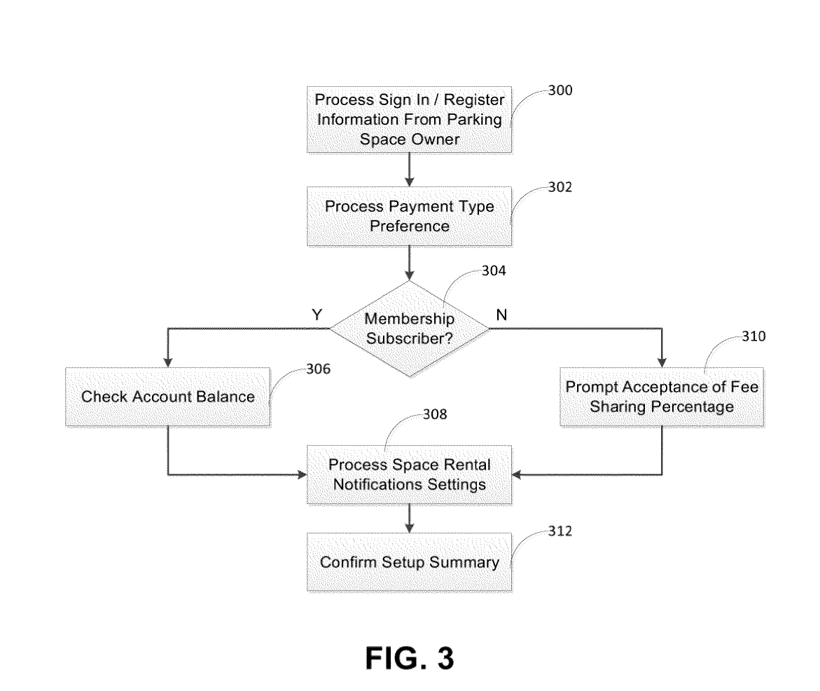

In an embodiment, the parking system 100 includes different categories of parking spaces, having corresponding availabilities, to encourage the driver's to sign up for a periodic membership. For example, the parking system 100 may include parking spaces that may only be reserved by the drivers having a membership account, as opposed to any driver who wishes to pay a one-time fee. In certain embodiments, members may also receive a discount on the space rental. In yet further embodiment, membership in the system is provided in exchange for user registration, with or without a periodic membership fee. Preferably, both members-only and non-members-only spaces are displayed for the driver via the graphical user interface 108 of the mobile device 106, computing device 118, and/or the vehicle's telematics unit. Members-only parking spaces may be graphically designated by a special symbol so as to inform the driver of this designation. Therefore, in step 208, the parking server 102 checks whether the selected parking space is a members-only space. If so, in step 210, the parking server 102 checks whether the driver has a subscription account. If not, the parking server 102 prompts the driver whether he or she wishes to undergo a subscription process in order to reserve the selected space. In step 212, if the subscription process is not completed, the process returns to step 200 to allow the driver to select non-members-only spaces. If, on the other hand, the driver undergoes a subscription process by providing his or her consent to periodic billing for system services and/or enters registration information, the parking server 102 proceeds to accepting a parking time selection from the driver, step 214. Next, in steps 216-218, the parking server 102 receives confirmation of a parking fee, which is further discussed below with reference to FIG. 3, and initializes display of remaining parking duration timer via the mobile device 106 and/or vehicle 104 telematics unit, for example. When the parking space reservation process completes, the subject parking space is graphically indicated as being unavailable (e.g., by graying out the parking space symbol 108 or changing the associated color from green to red, or the like, for the duration of the parking time selected in step 214). In one embodiment, the graphical display of personal parking spot locations that are part of the system includes not only the spots that are currently available but also provides a display of personal parking spots that will become available upon an expiration of a parking session. Such spaces may be displayed with a graphic indicating an occupied space (e.g. ,a car symbol in FIG. 1) along with a timer graphic showing when the space will become available (e.g., either a countdown timer or time of future availability display). In such an embodiment, drivers may reserve personal spaces that will become available upon expiration of a timer (e.g., via a bidding process described above or based on a first-come first-served reservation, for example).

FIG. 3 is a flow chart of a method for designating availability of a personal parking space by an interest holder in the space, such as the owner or lessee, who wishes to monetize temporary vacancy of his or her parking space. As discussed herein, an ownership interest in a parking space location may include, but is not limited to, a current ownership, a lease interest (in which case the space may be sub-rented or sub-let within the duration of the original rental or lease period), or another type ownership interest by an interest holder 114. In step 300, the parking server 102 receives and processes sign in information from a personal parking space interest holder 114. Alternatively or in addition, the parking server 102 receives registration information from first time users of the system that wish to monetize the availability of a parking space in which they hold an ownership interest. The parking sever 102 uses the sign in and registration information to verify that the interest holder indeed possesses the ownership interest during which the space may be (sub)rented, such as by collecting proof of such interest by way of scanned receipts, deeds, copies of a lease or rental agreement, or the like and setting a flag that an administrator review and approval is required for the parking space to be listed on the system 100. In an alternative embodiment, an automatic verification is performed by querying a database of recorded ownership interests. Once the verification process is completed, the interest holder is able to designate the space as being available for rent and the parking sever will graphically indicate availability of the space via the user interface 108 (FIG. 1). The parking server 102 then tracks and updates the availability status of the space throughout the time period that the space is listed on the system 100 (e.g., during the interest holder's ownership interest or a shorter time period designated by the interest holder).

In step 302, the parking sever 102 processes payment type preference received from the interest holder 114, for instance via a mobile device application. In an embodiment, the payment type preference indicates the payment mode (e.g., check, direct deposit) and frequency (e.g., daily, monthly) of receiving payments from parking space rentals by the interest holder 114. In step 304, the parking sever 102 checks whether the interest holder 114 has a subscription to the service. In various embodiments, if the interest holder 114 is a regular service subscriber he or she receives a higher percentage of the overall parking fee or an entire parking fee. Alternatively, if the interest holder 114 is a one-time user or a non-subscriber, a predetermined percentage of the total parking fee will be deducted from the parking fee that is due to the interest holder. Alternatively, higher percentage of the parking fee is deducted by the parking sever 102 for a non-subscriber as compared to a subscriber user. In embodiments where a predetermined percentage of the parking fee due to the interest holder is subtracted by the system 100, the remaining balance of the incoming parking fee is paid to the interest holder in accordance with the payment preferences. In yet further embodiment, personal space interest holders receive full parking fee amounts irrespective of their subscriber status, while subscriber benefits include unlimited space listings, enhanced graphical visibility of available parking spaces, and/or priority in displaying member spaces in search results and/or in map displays for the drivers looking for parking.

In the illustrated embodiment, for subscriber interest holders, the parking server 102 checks the subscriber's account balance to determine whether the subscription is active (step 306) and, if so, receives and processes the interest holder's parking space occupancy notification settings (step 308), such as settings directed to the mode and frequency of notifying the interest holder 114 regarding changes in the subject parking space's occupancy. Alternatively, for non-subscriber interest holder users, prior to processing the occupancy notification settings in step 308, the parking server, in step 310, prompts the user to accept the parking fee sharing arrangement, whereby the parking server 102 deducts a predetermined percentage of the total parking fee prior to paying the balance to the parking space interest holder. Finally, in step 312, the parking server 102 presents the parking space interest holder with the summary of the foregoing settings and obtains a confirmation to designate the parking space as being available for rent. In various embodiments, additional settings include whether the space may be automatically re-rented when it becomes unoccupied or whether interest holder's confirmation is required before the space can be re-designated as being available via the parking system 100.

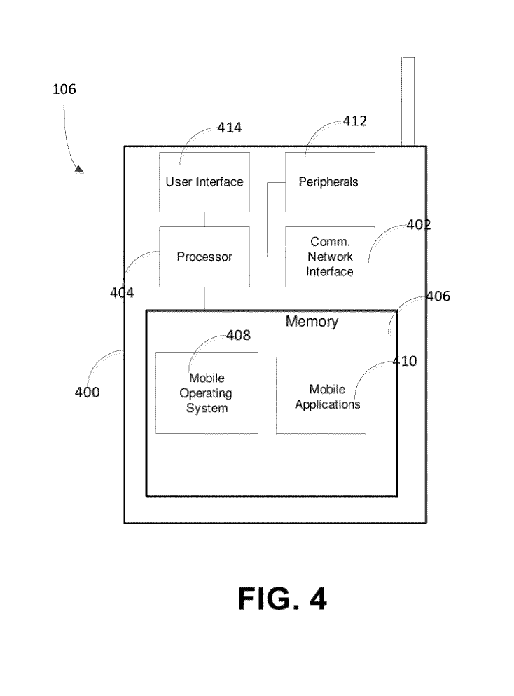

FIG. 4 illustrates an embodiment of a mobile device 106 of FIG. 1. In the illustrated embodiment, the mobile device 106 is a wireless device, such as a smartphone 400 having a communication interface 402 compatible with the network 122. The mobile device 106 further includes a processor 404 executing computer readable instructions stored in memory 406, including instructions corresponding to the mobile operating system 408 and mobile applications 410, including the mobile application executing, in cooperation with parking server 102, at least some steps of the methods discussed above in connection with FIGS. 2-3. The mobile device 106 further includes peripherals 412, such as USB connectors for data transfer and charging. The user interface 414 includes a touch screen and/or a keyboard for receiving user input and displaying the content, including graphical availability of the parking spaces and other user aspects of the parking system 100 discussed above in connection with FIGS. 1-3.

Unless specifically stated otherwise as apparent from the following discussion, it is appreciated that throughout the description, discussions utilizing terms such as “processing,” “computing,” “transmitting,” “receiving,” “determining,” “displaying,” “identifying,” “presenting,” “establishing,” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices. The system or portions thereof may be installed on an electronic device.

The exemplary embodiments can relate to an apparatus for performing one or more of the functions described herein. This apparatus may be specially constructed for the required purposes and/or be selectively activated or reconfigured by computer executable instructions stored in non-transitory computer memory medium.

It is to be appreciated that the various components of the technology can be located at distant portions of a distributed network and/or the Internet, or within a dedicated secured, unsecured, addressed/encoded and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term “module” as used herein can refer to any known or later developed hardware, software, firmware, or combination thereof that is capable of performing the functionality associated with that element.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Presently preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for facilitating utilization of a vehicle parking space comprising:
causing a computing device to graphically display a location of a personal parking space in geographic vicinity of a vehicle as being available for parking, wherein availability of said personal parking space is designated based on an input from an interest holder in the personal parking space;
receiving user selection of the available personal parking space;
receiving user selection of parking time during which the vehicle will occupy the selected personal parking space; and
designating the personal parking space as unavailable during the parking time selected by the user.

2. The method of claim 1 wherein the interest holder is an owner of the personal parking space.

3. The method of claim 1 wherein the interest holder is a lessee of the personal parking space.

4. The method of claim 1 wherein the computing device displays a plurality of available personal parking spaces, at least one of the plurality of personal parking spaces being graphically designated as a members-only space.

5. The method of claim 4 further comprising receiving user selection of the members-only parking space.

6. The method of claim 5 further comprising receiving a parking fee payment from the user, said parking fee payment for the members-only parking space including a member discount.

7. The method of claim 4 wherein the user is prompted to complete a membership registration when said user is not a member.

8. A system for facilitating utilization of a vehicle parking space comprising:
a computing device configured to graphically display a location of a personal parking space in geographic vicinity of a vehicle as being available for parking, wherein availability of said personal parking space is designated based on an input from an interest holder in the personal parking space; and
a parking server configured to
receive user selection of the available personal parking space;
receive user selection of parking time during which the vehicle will occupy the selected personal parking space; and
designate the personal parking space as unavailable during the parking time selected by the user.

9. The system of claim 8 wherein the interest holder is an owner of the personal parking space.

10. The system of claim 8 wherein the interest holder is a lessee of the personal parking space.

11. The system of claim 8 wherein the computing device displays a plurality of available personal parking spaces, at least one of the plurality of personal parking spaces being graphically designated as a members-only space.

12. The system of claim 11 wherein the parking server receives user selection of the members-only parking space.

13. The system of claim 12 wherein the parking server receives a parking fee payment from the user, said parking fee payment for the members-only parking space including a member discount.

14. The system of claim 11 wherein the user is prompted to complete a membership registration when said user is not a member.

15. A non-transitory computer readable medium having stored thereon computer executable instructions for facilitating utilization of a vehicle parking space, the instructions comprising:
causing a computing device to graphically display a location of a personal parking space in geographic vicinity of a vehicle as being available for parking, wherein availability of said personal parking space is designated based on an input from an interest holder in the personal parking space;
receiving user selection of the available personal parking space;
receiving user selection of parking time during which the vehicle will occupy the selected personal parking space; and
designating the personal parking space as unavailable during the parking time selected by the user.

16. The computer readable medium of claim 15 wherein the instructions further comprise displaying a plurality of available personal parking spaces, at least one of the plurality of personal parking spaces being graphically designated as a members-only space.

17. The computer readable medium of claim 16 wherein the instructions further comprise receiving user selection of the members-only parking space.

18. The computer readable medium of claim 17 wherein the instructions further comprise receiving a parking fee payment from the user, said parking fee payment for the members-only parking space including a member discount.

19. The computer readable medium of claim 16 wherein the instructions further comprise prompting the user to complete a membership registration when said user is not a member.

20. The computer readable medium of claim 15 wherein the interest holder is an owner of the personal parking space.
